(19) United States
(12) Patent Application Publication
(10) Pub. No.: US 2013/0247220 A1
(43) Pub. Date: Sep. 19, 2013

(54) CONTROLLING ACCESS TO DIGITAL IMAGES POST-TRANSMISSION

(71) Applicants: Nicholas D. Bingell, Raleigh, NC (US); Erich P. Hoppe, Apex, NC (US); Andrew J. Ivory, Wake Forest, NC (US); David M. Stecher, Durham, NC (US)

(72) Inventors: Nicholas D. Bingell, Raleigh, NC (US); Erich P. Hoppe, Apex, NC (US); Andrew J. Ivory, Wake Forest, NC (US); David M. Stecher, Durham, NC (US)

(73) Assignee: INTERNATIONAL BUSINESS MACHINES CORPORATION, Armonk, NY (US)

(21) Appl. No.: 13/423,415

(22) Filed: Mar. 19, 2012

(51) Int. Cl. G06F 21/24; G06F 15/16

(52) U.S. Cl. 726/28

(57) ABSTRACT

Embodiments of the present invention provide a system, method, and program product for controlling access to a digital image. A first computing device receives a digital image from a second computing device. The first computing device stores the digital image in local storage on the first computing device. The first computing device displays the digital image to an authorized user in a first user interface provided by the first computing device. Subsequently, in response to receiving instructions from the second computing device, the first computing device deletes the digital image from local storage on the first computing device. The first computing device can transmit a second digital image to another computing device for display in a user interface and, subsequently, transmit instructions to the other computing device that, when received, cause the other computing device to delete the digital image from local storage.

### TECHNICAL FIELD

The present invention relates generally to digital images, and more particularly to remotely controlling access to digital images after they have been transmitted to, and stored locally on, a computing device.

### BACKGROUND

Many modern computing devices, such as desktop computers, laptop computers, tablet computers and cellular telephones, enable users to send digital images to recipients who are using other such computing devices. Typically, once a user sends a digital image to a recipient and it is stored on the recipient's computing device, the recipient may freely access and further distribute the digital image. However, a recipient's use and distribution of the digital image may not always comport with the sender's wishes. Further, a user may send a digital image to a recipient, but then at a later time, wish to have the digital image deleted to prevent the recipient and others from accessing it.

One technique to enable computing device users to control access to digital messages after they have been sent to a recipient involves setting message timeouts. For example, a user can create a cellular text message with a five-hour timeout and send it to a recipient. After the five hours have elapsed, the text message is automatically deleted from the recipient's cellular telephone. However, this technique requires a user to predetermine a timeout period before sending the message. If a user's circumstances change after sending the message, the user cannot adjust the timeout period or remotely delete the message at will.

Other techniques for controlling access to digital messages after they have been sent to a recipient involve intercepting or otherwise preventing the sent messages from being downloaded and stored on a recipient's computing device. For example, when a user sends an e-mail message to a recipient, the message is transmitted to a remote e-mail server, where it is stored until the recipient accesses his or her e-mail inbox and downloads the message from the server to his or her computing device. After sending the e-mail message to the recipient, but prior to the recipient downloading the message, the user can delete the message from the e-mail server, thereby preventing the recipient from downloading and accessing the message.

### SUMMARY

Embodiments of the present invention provide a system, method, and program product for controlling access to a digital image. A first computing device receives a digital image from a second computing device. The first computing device stores the digital image in local storage on the first computing device. The first computing device displays the digital image to an authorized user in a first user interface provided by the first computing device. Subsequently, the first computing device receives instructions from the second computing device to disallow the digital image from being displayed in the first user interface. Responsive to receiving the instructions, the first computing device deletes the digital image from local storage on the first computing device. In certain embodiments, the first computing device replaces the deleted digital image with another digital image specified by the second computing device.

In certain embodiments of the present invention, the first computing device receives at the first user interface a request to transmit a second digital image to another computing device, upon which the first computing device transmits the second digital image to the other computing device for display to an authorized user in a user interface provided by the other computing device. Subsequently, in response to receiving a request, the first computing device transmits instructions to the other computing device that, when received by the other computing device, cause the other computing device to delete the digital image from local storage on the other computing device.

In certain embodiments of the present invention, the first computing device prevents an unauthorized user from accessing the digital image. In certain embodiments of the present invention, the digital image received by the first computing device is encrypted and, prior to displaying the digital image to an authorized user, the first computing device decrypts the encrypted digital image.

### BRIEF DESCRIPTION OF THE SEVERAL VIEWS OF THE DRAWINGS

FIG. 1 is a functional block diagram of an image messaging system in accordance with an embodiment of the present invention.

FIGS. 2A and 2B are flowcharts illustrating the operational steps for transmitting and accessing an image message in accordance with embodiments of the present invention.

FIG. 3 is a flowchart illustrating the operational steps for accessing an image message in accordance with another embodiment of the present invention.

FIGS. 4A and 4B are flowcharts illustrating the operational steps for transmitting and receiving a delete command in accordance with embodiments of the present invention.

FIGS. 5 through 7 show illustrations of user interfaces for transmitting, accessing, and remotely deleting or replacing an image message in accordance with embodiments of the present invention.

FIG. 8 is a block diagram of internal and external components of the computing devices of FIG. 1 in accordance with an embodiment of the present invention.

### DETAILED DESCRIPTION

Embodiments of the present invention will now be described in detail with reference to the accompanying drawings.

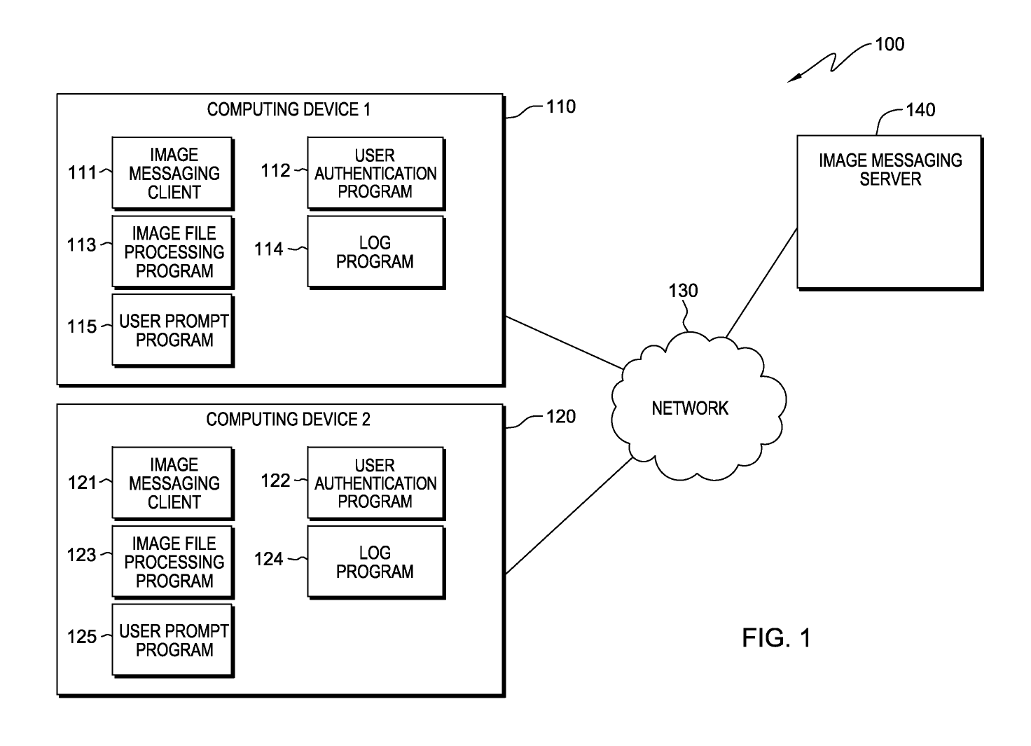

FIG. 1 is a functional block diagram of an image messaging system 100 in accordance with an embodiment of the present invention. Image messaging system 100 includes computing device 110, computing device 120, and image messaging server 140 interconnected over network 130.

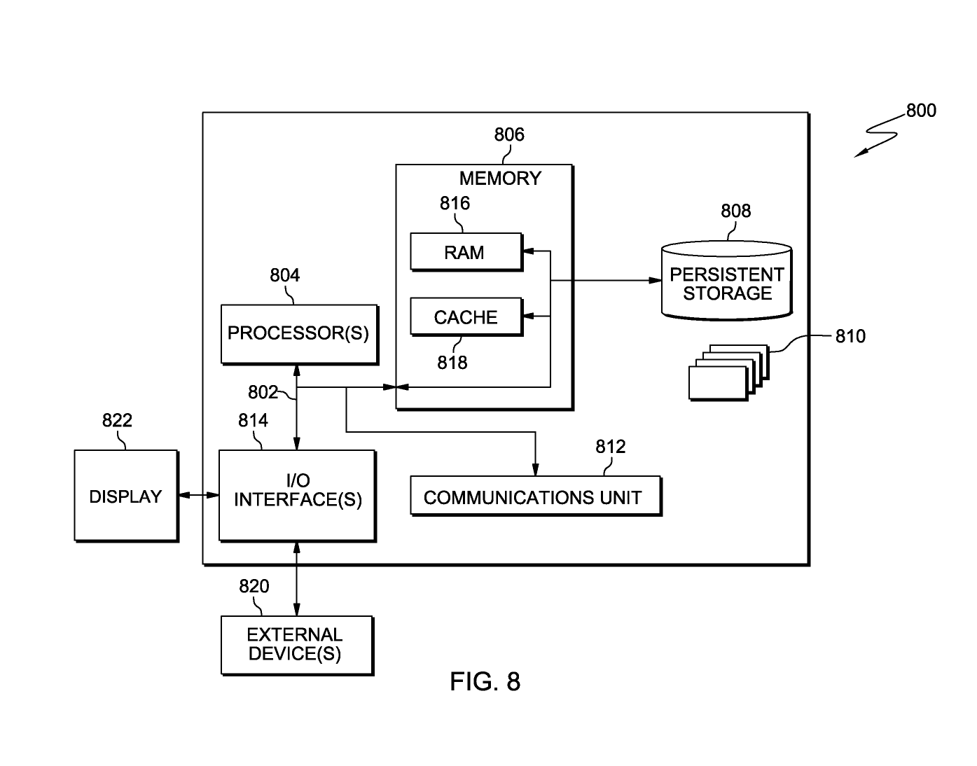

Computing device 110, computing device 120, and image messaging server 140 can be laptop computers, desktop computers, specialized computer servers, or any other computer systems known in the art. In general, computing device 110, computing device 120, and image messaging server 140 can be any programmable electronic devices as described in further detail with regard to FIG. 8. In a preferred embodiment, computing device 110 and computing device 120 are mobile computing devices such as, for example, cellular telephones or tablet computers. It should be understood that, for the purpose of illustration, FIG. 1 does not show other computing devices and elements which may be present when implementing an embodiment of the present invention such as, for example, additional computing devices in communication with messaging server 140 with which additional users can transmit and receive encrypted or unencrypted image messages.

Computing device 110 includes image messaging client 111, user authentication program 112, image file processing program 113, log program 114, and user prompt program 115. Image messaging client 111 and programs 112 through 115 enable an authorized user to create an encrypted image message, transmit the encrypted image message via network 130 to image messaging server 140 for delivery to computing device 120, and remotely delete or replace the delivered encrypted image message stored locally on computing device 120 in accordance with embodiments of the present invention. Image messaging client 111 and programs 112 through 115 also enable an authorized user to receive, decrypt, and access an encrypted image message transmitted from computing device 120 in accordance with embodiments of the present invention.

Computing device 120 includes the same image messaging client and programs as computing device 110, respectively numbered 121 through 125. Image messaging client 121 and programs 122 through 125 enable an authorized user to create an encrypted image message, transmit the image message via network 130 to image messaging server 140 for delivery to computing device 110, and remotely delete or replace the delivered encrypted image message stored locally on computing device 110 in accordance with embodiments of the present invention. Image messaging client 121 and programs 122 through 125 also enable an authorized user to receive, decrypt, and access an encrypted image message transmitted from computing device 110 in accordance with embodiments of the present invention.

While each computing device is capable of both transmitting and receiving encrypted image messages, hereinafter, for purposes of illustration and explanation, computing device 110, image messaging client 111, and programs 112 through 115 will be discussed with regard to their capacity of enabling an authorized user to create an encrypted image message, transmit the encrypted image message via network 130 to image messaging server 140 for delivery to computing device 120, and remotely delete or replace the delivered encrypted image message stored locally on computing device 120 in accordance with embodiments of the present invention. Computing device 120, image messaging client 121, and programs 121 through 125 will be discussed with regard to their capacity of enabling an authorized user to receive, decrypt, and access an encrypted image message transmitted from computing device 110 in accordance with embodiments of the present invention.

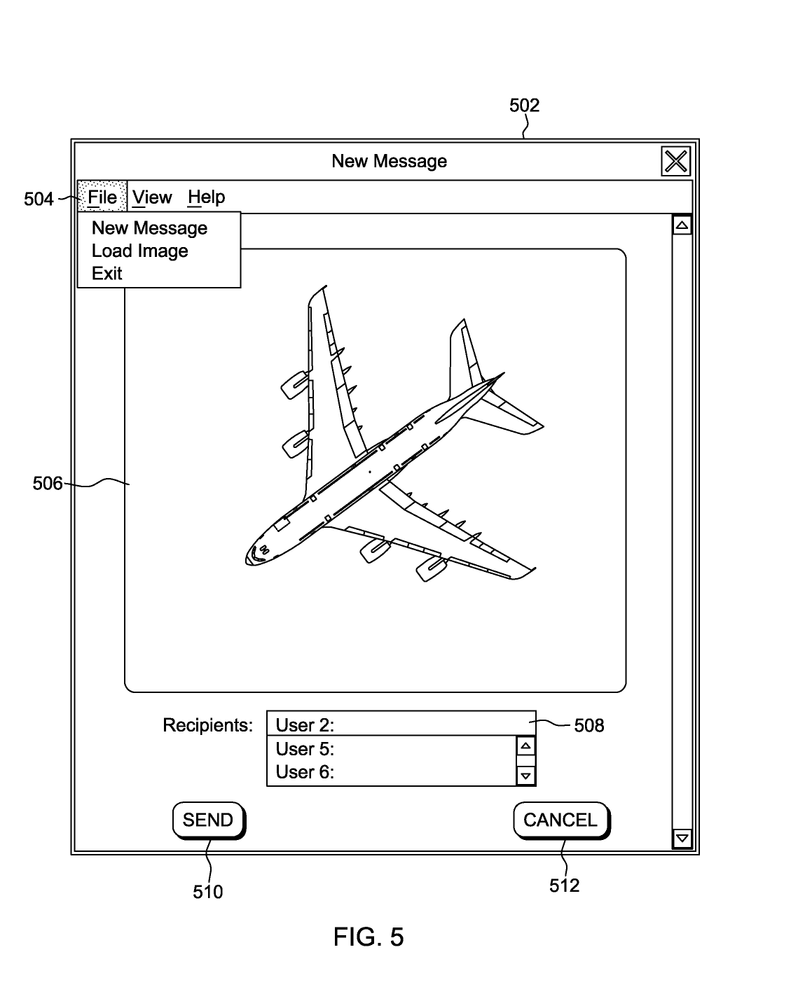

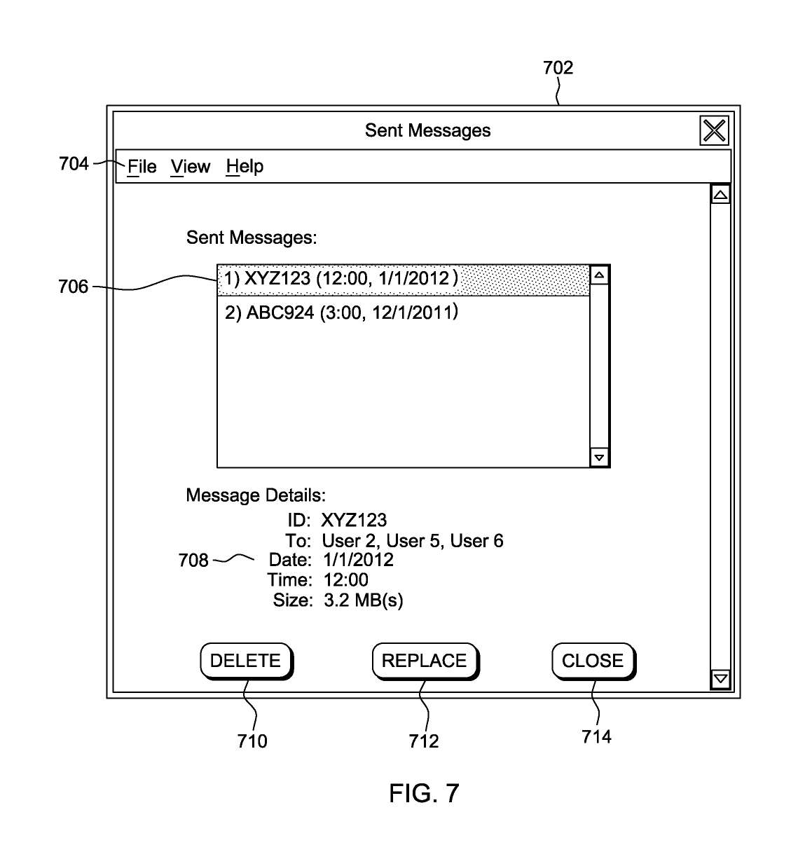

Image messaging client 111 is one or more software programs that provide a graphical user interface (UI) through which an authorized user can create an encrypted image message, transmit the encrypted image message to image messaging server 140, and remotely delete or replace an encrypted image message stored locally on computing device 120, as explained in greater detail with regard to FIGS. 5 and 7. Image messaging client 111 also provides a background service that can run when a user is not actively using the UI, maintaining communications with image messaging server 140 via network 130. In one embodiment, image messaging program 111 calls programs 112 through 115 as necessary. In another embodiment, programs 112 through 115 can operate as functions of image messaging client 111.

In response to image messaging client 111 calling or otherwise triggering execution of programs 112 through 115, user authentication program 112 ensures only authorized users operate image messaging client 111; image file processing program 113 creates an encrypted image message with appended metadata prior to transmission; log program 114 logs file attributes and historical data related to transmitted image messages and image messages that have been remotely deleted or replaced; and user prompt program 115 provide prompts and notifications to a user of computing device 110.

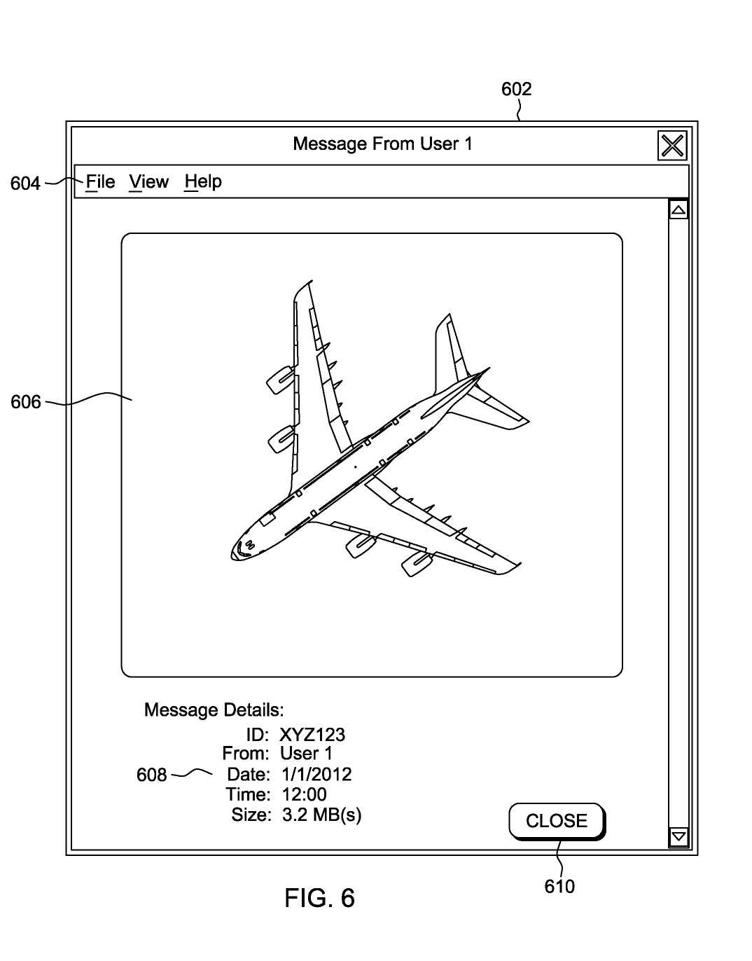

Image messaging client 121 is one or more software programs that provide a UI through which an authorized user can receive, decrypt, and access an image message transmitted from computing device 110, as explained in greater detail with regard to FIG. 6. Image messaging client 121 also provides a background service that can run when a user is not actively using the UI, maintaining communications with image messaging server 140 via network 130. In one embodiment, image messaging program 121 calls programs 122 through 125 as necessary. In another embodiment, programs 122 through 125 can operate as functions of image messaging client 111.

In response to image messaging client 121 calling or otherwise triggering execution of programs 122 through 125, user authentication program 122 ensures only authorized users operate image messaging client 121; image file processing program 123 reads the appended metadata of an encrypted image message received from computing device 110 and decrypts the encrypted image message; log program 124 logs file attributes and historical data related to received encrypted image messages and encrypted image messages that have been remotely deleted or replaced; log program 124 logs file paths for encrypted image messages stored locally on computing device 120; and user prompt program 125 provides prompts and notifications to a user of computing device 120.

Computing device 110, computing device 120, and image messaging server 140 each include respective internal components and external components as discussed with regard to FIG. 8.

Network 130 can be, for example, a local area network (LAN), a wide area network (WAN) such as the Internet, or a combination of the two, and can include wired, wireless, or fiber optic connections. In general, network 130 can be any combination of connections and protocols that will support communications between computing device 110, computing device 120, and image messaging server 140 in accordance with embodiments of the invention.

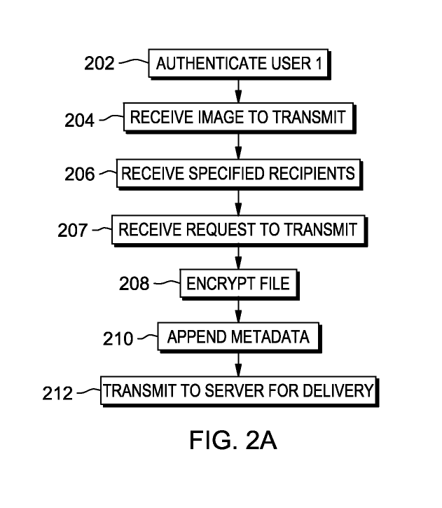

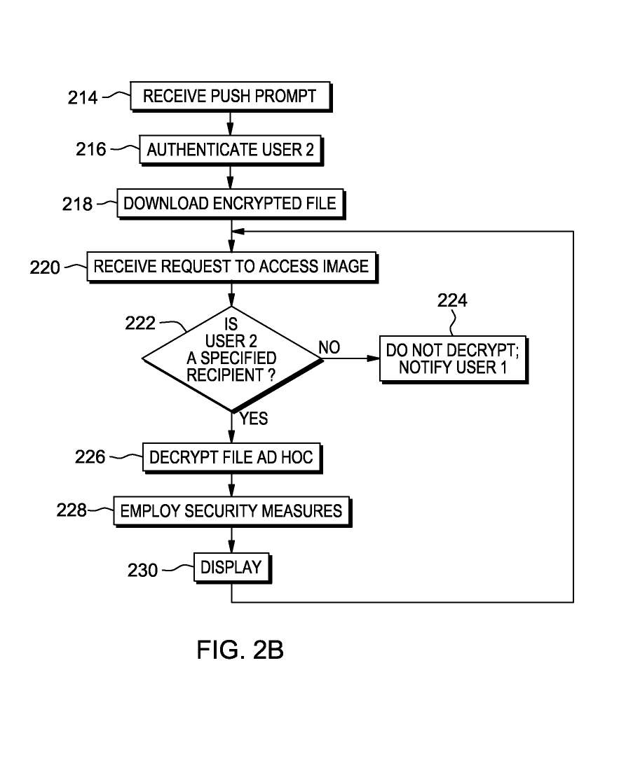

Image messaging server 140, via network 130, receives encrypted image messages transmitted by computing device 110 and delivers them to computing device 120. Image messaging server 140 can also deliver instructions and notifications to both computing device 110 and computing device 120, as explained in greater detail with regard to FIGS. 2A through 4B.

FIGS. 2A and 2B are flowcharts illustrating the operational steps for transmitting and accessing an image message, respectively, in accordance with embodiments of the present invention. In these embodiments, only authorized users can use image messaging client 111 on computing device 110 and image messaging client 121 on computing device 120, with each user having unique credentials. For example, each user can have a unique identification number or name (“user ID”) and password. Further, these exemplary embodiments only involve two users: the user of computing device 110 (“the first user”) and the user of computing device 120 (“the second user”). In other embodiments, multiple users, each having unique credentials, can be authorized to use image messaging client 111 and image messaging client 121, and more than two computing devices can be involved in transmitting and receiving image messages.

Referring now to FIG. 2A, in step 202, image messaging client 111 authenticates the first user as an authorized user. Image messaging client 111 receives user credentials inputted by the first user. In a preferred embodiment, image messaging client 111 generates a graphical login form into which the first user can enter his or her user ID and password. Upon receiving the user credentials inputted by the first user, image messaging client 111 passes the data to user authentication program 112. In a preferred embodiment, user authentication program 112 communicates with an external server, such as image messaging server 140, to authenticate the first user as an authorized user. For example, image messaging server 140 can maintain a secure database of authorized users and their credentials and, upon receiving a verification request from authentication program 112, determine whether the inputted credentials match any of those contained in the database.

After the first user is authenticated as an authorized user, in step 204, image messaging client 111 receives data inputted by the first user representative of the image the first user wishes to transmit in an image message. In a preferred embodiment, the first user inputs the data by selecting a “Load Image” option in a graphical message form generated by image messaging client 111 and then specifying the file path of the image. The graphical message form can then display the specified image, enabling the first user to verify that the appropriate image will be transmitted.

In step 206, image messaging client 111 receives data inputted by the first user representative of the intended recipients of the image message. In a preferred embodiment, the first user can specify one or more intended recipients by entering their respective user ID's into a field on the graphical message form generated by image messaging client 111. As discussed earlier, in this exemplary embodiment, the second user is the only intended recipient.

In step 207, image messaging client 111 receives a request to transmit the image message to the second user, after which image messaging client 111 calls image file processing program 113. In a preferred embodiment, step 207 involves the first user selecting a “Send” button on the graphical message form generated by image messaging client 111.

In step 208, image file processing program 113 creates an encrypted image message containing a copy of the image specified by the first user in step 204. The image message can be encrypted using known symmetric encryption techniques, asymmetric encryption techniques, or a combination of the two. In general, step 208 can involve any encryption technique that allows only the second user to decrypt the encrypted image message and access the image through image messaging client 121 (in later steps).

In step 210, image file processing program 113 appends metadata to the encrypted image message that is readable without decrypting the encrypted image message. In a preferred embodiment, the metadata includes at least the first user's user ID, a unique image message identifier (“message ID”), a time stamp indicating when the encrypted image message was created, the file size of the encrypted image message, and user ID's of the specified recipients.

In step 212, image messaging client 111 transmits the encrypted image message with appended metadata to image messaging server 140 via network 130, and calls log program 114. Log program 114 logs the log file attributes and historical data related to the transmitted encrypted image message. In a preferred embodiment, log program 114 logs at least the message ID of the transmitted image message, the specified recipients to whom the image message was transmitted, the time and date of the transmission, and the file size of the transmitted image message.

In a preferred embodiment, after being transmitted to image messaging server 140, the encrypted image message is stored on image message server 140. Image messaging server 140 asynchronously (i.e., without receiving a request from image messaging client 121) transmits a push notification to image messaging client 121 on computing device 120 via network 130 indicating that the first user has transmitted an image message and it is available for download.

Referring now to FIG. 2B, in step 214, image messaging client 121 on computing device 120 receives the push notification from image messaging server 140. In a preferred embodiment, the second user need not be actively using the UI for image messaging client 121 to receive the push notification because the background service provided by image messaging client 121 maintains communications with image messaging server 140 and receives the push notification from image messaging server 140. After receiving the push notification from image messaging server 140, image messaging client 121 calls user prompt program 125 to display the content of the push notification to the second user. In a preferred embodiment, user prompt program 125 displays a graphical prompt window that indicates that the first user has transmitted an image message and it is available for download.

In step 216, image messaging client 121 authenticates the second user as an authorized user. Image messaging client 121 receives user credentials inputted by the second user. As in step 202 of FIG. 2A, in a preferred embodiment, image messaging client 121 generates a graphical login form into which the second user can enter his or her user ID and password. Upon receiving the user credentials inputted by the second user, image messaging client 121 passes the data to user authentication program 122. As in step 202 of FIG. 2A, in a preferred embodiment, user authentication program 122 communicates with an external server to authenticate the second user as an authorized user.

After the second user is authenticated as an authorized user, in step 218, image messaging client 121 downloads the encrypted image message from image messaging server 140 via network 130, stores the encrypted image message locally on computing device 120, and calls log program 124. After downloading the encrypted image message, the encrypted image message is deleted from image messaging server 140. Log program 124 logs file attributes and historical data related to the encrypted image message and also logs the file path for the encrypted image message stored locally on computing device 120. In a preferred embodiment, log program 124 logs at least the message ID of the encrypted image message, the user ID of the first user, and the time and date the encrypted image message was downloaded from image messaging server 140. In a preferred embodiment, image messaging client 121 can also lock the read and write file permissions of the downloaded encrypted image message, granting only the second user those permissions.

In step 220, image messaging client 121 receives a request to access the encrypted image message stored locally on computing device 120, upon which image messaging client 121 calls image file processing program 123. In a preferred embodiment, step 220 involves the second user selecting the encrypted image message from a list displayed in a graphical window generated by image messaging client 121.

In step 222, image file processing program 123 determines whether the second user is a specified recipient of the encrypted image message. In a preferred embodiment, image file processing program 123 reads the metadata appended to the encrypted image message, which includes the user ID's of each specified recipient, to determine whether the second user's user ID matches a specified recipient's user ID. While the second user must be authenticated as an authorized user back at step 216, step 222 of this embodiment can be useful, for example, in situations where multiple authorized users have access to computing device 120 but are not all specified recipients for all encrypted image messages that may be stored locally on computing device 120. For example, a third user may also be an authorized user of image messaging client 121 but not be a specified recipient of the encrypted image message discussed in this exemplary embodiment. Step 222, then, would help prevent that third user from accessing the encrypted image message stored locally on computing device 120.

If image file processing program 123 determines that the second user is not a specified recipient of the encrypted image message, then, in step 224, image file processing program 123 does not decrypt the encrypted image message, and the second user is unable to view the image contained therein. Image messaging client 112 can also transmit a notification to the first user via network 130 and image messaging server 140 pertaining to an unauthorized attempt to access the encrypted image message.

If, in step 222, image file processing program 123 determines that the second user is a specified recipient of the encrypted image message (as is the case in this exemplary embodiment), then, in step 226, image file processing program 123 decrypts the encrypted image message. In a preferred embodiment, image file processing program 123 decrypts the encrypted image message in an ad hoc manner. That is, image file processing program 123 does not create and store a decrypted copy of the image message on computing device 120; the encrypted image message stored locally on computing device 120 remains encrypted, and image file processing program 123 decrypts the image message only for the purpose of temporary displaying the image to the second user in a later step.

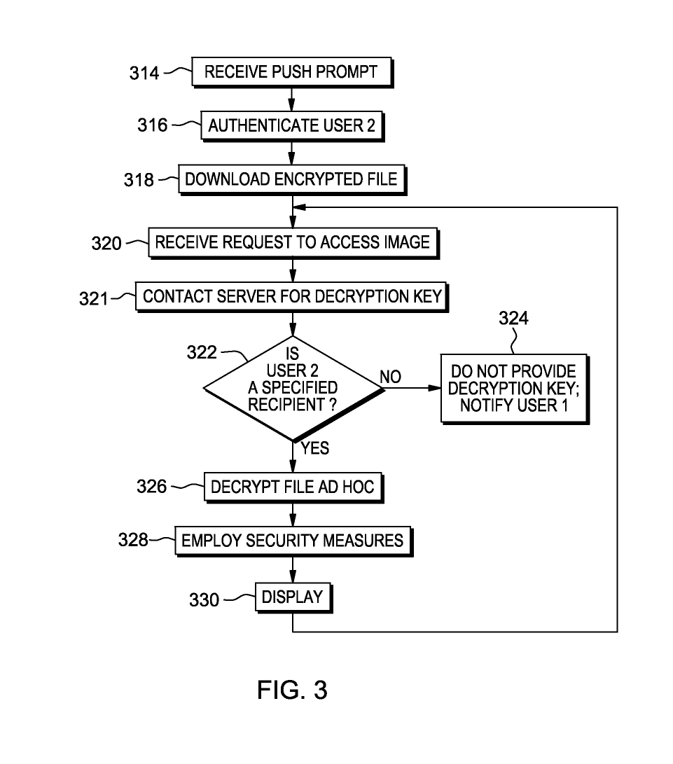

Depending on the encryption technique used in step 208, the key required to decrypt the encrypted image message may be provided in different manners. For example, in some embodiments of the present invention, the decryption key can be stored locally on computing device 120 or be inputted by the second user. The type of the decryption key can also vary. For example, in some embodiments of the present invention, the decryption key can be a key possessed by the second user that is capable of decrypting all encrypted image messages of which the second user is a specified recipient. In another embodiment, such as the embodiment discussed in FIG. 3, the decryption key can be a key that is specific to the encrypted image message and is transmitted to image messaging client 121 each time the second user accesses the encrypted image message, as opposed to being in the second user's possession or stored locally on computing device 120.

In step 228, image messaging client 121 employs additional security measures intended to further help prevent unauthorized distribution of the image by the second user and other access to the image by third parties. In a preferred embodiment, step 228 involves image messaging client 121 disabling print screen and other screen capture functionalities on computing device 120 and pulsing the display of computing device 120 to prevent a camera from capturing a picture of the content on the display. For example, computing device 120 can continually alternate between displaying content to the second user (e.g., the image in step 230) and displaying a blank white screen, or computing device 120 can modify the refresh rate of the display to obscure any pictures taken by a camera.

In step 230, image messaging client 121 displays the image contained in the image message to the second user. In a preferred embodiment, the image is displayed to the second user in a graphical message window generated by image messaging client 121 which only permits the second user to view the image and close the message form.

After step 230, each instance of the second user subsequently accessing the encrypted image message stored locally on computing device 120 involves repeating the operational steps back at step 220.

FIG. 3 is a flowchart illustrating the operational steps for accessing an image message in accordance with another embodiment of the present invention. As in the embodiments depicted in FIGS. 2A and 2B, this exemplary embodiment only involves two users: the user of computing device 110 (“the first user”) who transmitted the image message and the user of computing device 120 (“the second user”). Further, operational steps 314 through 320, and 328 and 330, are equivalent to operation steps 214 through 220, and 228 and 230 of FIG. 2B, respectively. Accordingly, for an explanation of these operational steps please refer to the discussion of FIG. 2B.

In step 321, image messaging client 121 contacts image messaging server 140 to obtain the specific decryption key required to decrypt the encrypted image message, as opposed to the key being in the second user's possession or stored locally on computing device 120. In this exemplary embodiment, image messaging server 140 securely stores the decryption key required to decrypt the encrypted image message. Image messaging client 121 transmits to image messaging server 140 data pertaining to the second user and the encrypted image message the second user is attempting to access. In a preferred embodiment, image messaging client 121 transmits to image messaging server 140 at least the second user's user ID and the message ID of the encrypted image message stored locally on computing device 120.

In step 322, image messaging server 140 determines whether the second user is a specified recipient of the encrypted image message. For example, image messaging server 140 can maintain a secured record of the encrypted image messages it has delivered to computing device 120 and the specified recipients of those encrypted image messages, to which it can compare the data received from image messaging client 121 in step 321. In another embodiment, image messaging server 140 can request verification of the second user as a specified recipient of the encrypted image message from image messaging client 111 on computing device 110, which possesses its own log (for example, from step 212 of FIG. 2A) of transmitted encrypted image messages and their specified recipients.

If image messaging server 140 determines that the second user is not a specified recipient of the encrypted image message, then, in step 324, image messaging server 140 does not transmit the decryption key to image messaging client 121, and the second user is unable to view the image contained in the encrypted image message. Image messaging server 140 can also transmit a notification to the first user via network 130 pertaining to an unauthorized attempt to access the encrypted image message.

If, in step 322, image messaging server 140 determines that the second user is a specified recipient of the encrypted image message (as is the case in this exemplary embodiment), then, in step 326, image messaging server 140 transmits the decryption key to image messaging client 121, which then calls image file processing program 123 to decrypt the encrypted image message. In a preferred embodiment, image file processing program 123 decrypts the encrypted image message in an ad hoc manner, as discussed with regard to FIG. 2B, but does not store the decryption key for repeated use.

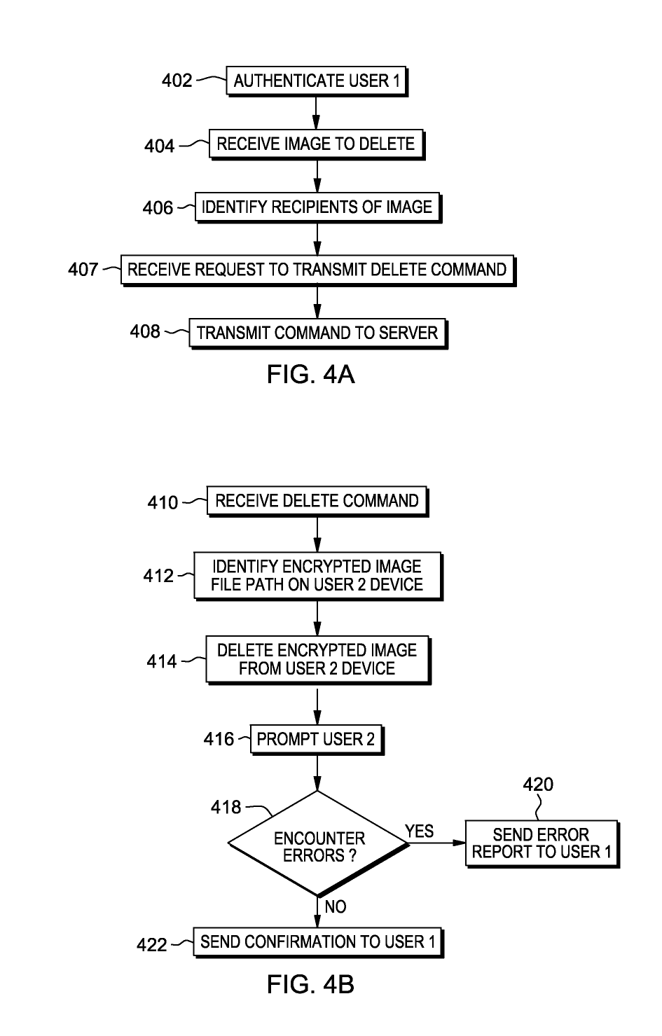

FIGS. 4A and 4B are flowcharts illustrating the operational steps for transmitting and receiving a delete command, respectively, in accordance with embodiments of the present invention. Again, the exemplary embodiments depicted in FIGS. 4A and 4B only involve two users: the user of computing device 110 (“the first user”) who transmitted the image message and the user of computing device 120 (“the second user”). The operational steps depicted in FIGS. 4A and 4B are performed after transmitting and accessing an image message in accordance with embodiments of the present invention such as, for example, in accordance with the operational steps depicted in FIG. 2A and FIGS. 2B and 3, respectively. Other embodiments of the present invention can involve additional users and computing devices. For example, the first user can remotely delete an encrypted image message that is stored locally on multiple computing devices as a result of multiple users being specified recipients of the transmitted encrypted image message.

In step 402, image messaging client 111 authenticates the first user as an authorized user. Image messaging client 111 receives user credentials inputted by the first user. In a preferred embodiment, image messaging client 111 generates a graphical login form into which the first user can enter his or her user ID and password. Upon receiving the user credentials inputted by the first user, image messaging client 111 passes the data to user authentication program 112. In a preferred embodiment, user authentication program 112 communicates with an external server to authenticate the first user as an authorized user, as discussed earlier with regard to FIGS. 2A, 2B and 3.

After the first user is authenticated as an authorized user, in step 404, image messaging client 111 receives data inputted by the first user representative of the encrypted image message the first user wishes to remotely delete from computing device 120. In a preferred embodiment, step 404 involves the first user selecting the encrypted image message from a list of the first user's transmitted encrypted image messages, the list being displayed in a graphical window generated by image messaging client 111.

In step 406, image messaging client 111 identifies the recipients of the encrypted image message which is to be remotely deleted. In a preferred embodiment, image messaging client 111 identifies the recipients by obtaining the recipients' user ID's from logs that were created by log program 114 upon transmitting the encrypted image message such as, for example, the logs created in operational step 212 of FIG. 2A.

In step 407, image messaging client 111 receives a request to transmit a delete command to computing device 120. In a preferred embodiment, step 407 involves the first user selecting a “Delete” button in a graphical window generated by image messaging client 111. Image messaging client 111 then generates the delete command, which includes instructions for image messaging client 121 to delete the encrypted image message stored locally on computing device 120.

In step 408, image messaging client 111 transmits the delete command to image messaging server 140 via network 130, and calls log program 114. Log program 114 logs historical data related to the transmitted delete command. In a preferred embodiment, log program 114 logs at least the message ID of the encrypted image message to be deleted, the specified recipients to whom the delete command was transmitted, and the time and date of the transmission.

In a preferred embodiment, after transmitting the delete command to image messaging server 140, image messaging server 140 asynchronously pushes the delete command to image messaging client 121 via network 130.

Referring now to FIG. 4B, in step 410, image messaging client 121 on computing device 120 receives the pushed delete command from image messaging server 140. In a preferred embodiment, the second user need not be actively using the UI for image messaging client 121 to receive the delete command because the background service provided by image messaging client 121 maintains communications with image message server 140 and receives the pushed command from image messaging server 140.

After receiving the delete command, in step 412, image messaging client 121 identifies the file path of the encrypted image message stored locally on computing device 120. In a preferred embodiment, image messaging client 121 identifies the file path from logs that were created by log program 124 at the time of downloading the encrypted image message to computing device 120 such as, for example, the logs created in operational steps 218 and 318 of FIGS. 2B and 3, respectively.

In step 414, image messaging client 121 deletes the encrypted image message from computing device 120. In step 416, image messaging client 121 calls user prompt program 125. In a preferred embodiment, user prompt program 125 displays a graphical prompt window to the second user that indicates that the first user has remotely deleted the encrypted image message.

In step 418, image messaging client 121 determines whether any errors were encountered in the process of deleting the encrypted image message. In a preferred embodiment, image messaging client 121 attempts to access the encrypted image message at its logged file path to confirm that the encrypted image message has been deleted. If image messaging client 121 determines that an error was encountered (e.g., the encrypted image message was not deleted), then, in step 420, image messaging client 121 transmits an error report to the first user via network 130 and image messaging server 140 which specifies the nature of the error. If, in step 418, image messaging client 121 determines that an error was not encountered, then, in step 422, image messaging client 121 transmits a confirmation to the first user via network 130 and image messaging server 140 indicating that no errors were encountered (e.g., the encrypted image message was successfully deleted).

While FIGS. 4A and 4B illustrate the operational steps for remotely deleting an encrypted image message in accordance with embodiments of the present invention, other embodiments involve remotely replacing an encrypted image message stored locally on computing device 120 with another file, such as, for example, another encrypted image message specified by the first user.

In general, the operational steps of FIGS. 2A through 4B are illustrative of embodiments of the present invention. It should be understood that the content of each step, as well as the order of operation, can be modified without departing from the spirit and intended scope of the present invention.

FIG. 5 shows a UI being operated by the first user to create and transmit an encrypted image message with image messaging client 111 in accordance with an embodiment of the present invention. Shown is a graphical message form 502 that was generated by image messaging client 111. Graphical message form 502 includes a menu bar 504, an image display region 506, an intended recipient field 508, a send command button 510, and a cancel command button 512.

Menu bar 504 provides options that the first user can select. For example, the “New Message” option opens a new graphical message form 502; the “Load Image” option allows the first user to specify the image to be transmitted in an encrypted image message; and the “Exit” option allows the first user to exit the UI provided by image messaging client 111. In this example, the first user has already selected the “Load Image” option and specified an image (i.e., an airplane image). Within the “View” menu are options (not shown) to view received image message and messages that have been transmitted, as discussed further with regard to FIGS. 6 and 7.

Image display region 506 displays the image selected by the first user (i.e., the airplane image), which allows the first user to visually confirm that the appropriate image will be transmitted.

Intended recipient field 508 is an input field in which the first user can specify one or more intended recipients of the encrypted image message. In this example, the first user has specified the second user (User 2), User 5, and User 6 as intended recipients of the image message.

Send command button 510, if selected by the first user, initiates transmission of the image message to the intended recipients specified in intended recipient field 508, upon which the encrypted image message with metadata is created and transmitted to image messaging server 140 for delivery to the specified recipients. Cancel command button 512, if selected, closes graphical message form 502 without saving or transmitting the image message. In this example (and for the purposes of FIGS. 6 and 7), the first user has selected send command button 510 and the metadata (not shown) includes a message ID (XYZ123), the first user's user ID (User 1), a time stamp indicating when the encrypted image message was created (Jan. 1, 2012; 12:00), and the file size of the encrypted image message (3.2 MB).

FIG. 6 shows a UI for accessing an encrypted image message with image messaging client 121 in accordance with an embodiment of the present invention. In the example depicted in FIG. 6, the second user is interacting with the UI to access the image message that was transmitted by the first user in the example discussed with regard to FIG. 5. Graphical message window 602 is generated by image messaging client 121. Graphical message window 602 includes a menu bar 604, an image display region 606, a message details region 608, and a close command button 610.

Menu bar 604 provides the same options as menu bar 504. Within the “View” menu, the second user can select an option (not shown) to view the image message received from the first user. In the example depicted in FIG. 6, the second user has already selected such an option.

Image display region 606 displays the image contained in the encrypted image message received from the first user (i.e., the airplane image). Message details region 608 displays the metadata that was appended to the encrypted image message. The metadata displayed in message details region 608 includes the message ID (XYZ123), the first user's user ID (User 1), the time stamp data (Jan. 1, 2012; 12:00), and the file size (3.2 MB). In other embodiments, message details region 608 can display data obtained from logs that were created by log program 124 upon receiving the transmitted image message. Close command button 610, if selected by the second user, closes graphical message window 602.

FIG. 7 shows a UI for remotely deleting or replacing an encrypted image message with image messaging client 111 in accordance with an embodiment of the present invention. In the example depicted in FIG. 7, the first user is interacting with the UI to remotely delete or replace the encrypted image message that was transmitted to the second user in the example discussed with regard to FIG. 5. Graphical message window 702 is generated by image messaging client 111. Graphical message window 702 includes a menu bar 704, a sent messages list 706, a message details region 708, a delete command button 710, a replace command button 712, and a close command button 714.

Menu bar 704 provides the same options as menu bars 504 and 604. Within the “View” menu, the second user can select an option (not shown) to view transmitted image messages. In the example depicted in FIG. 7, the first user has already selected such an option.

Sent messages list 706 displays a list of transmitted encrypted image messages and enables the first user to select a transmitted encrypted image message to remotely delete or replace. In this example, each entry includes a message ID and timestamp data for reference. In this example, the first user has transmitted two encrypted image messages, the first of which is the encrypted image message discussed with regard to FIGS. 5 and 6.

Message details region 708 displays data associated with the transmitted encrypted image message selected by the first user in sent messages list 706. In this example, the first user has selected the encrypted image message discussed with regard to FIGS. 5 and 6 (shown as being highlighted), and message details region 708 displays its associated message ID (XYZ123), specified recipients (User 2, User 5, User 6), time stamp data (Jan. 1, 2012; 12:00), and file size (3.2 MB). In this embodiment, the data associated with the encrypted image message is obtained from logs that were created by log program 114 upon transmitting the encrypted image message.

Delete command button 710, if selected by the first user, initiates transmission of a delete command to the recipients of the encrypted image message selected by the first user in sent messages list 706, after which the encrypted image message stored locally on the recipients' computing devices will be deleted. Replace command button 712, if selected by the first user, initiates transmission of a replace command to the recipients of the encrypted image message selected by the first user in sent messages list 706, after which the encrypted image message stored locally on the recipients' computing devices will be replaced with a file chosen by the first user. In the embodiment depicted, the delete or replace commands will be transmitted to all recipients of the selected image message. In other embodiments, the first user can select individual recipients to which to transmit the delete or replace commands. Close command button 714, if selected by the first user, closes graphical message window 702.

FIG. 8 is a block diagram of internal and external components of a computing system 800, such as computing devices 110 and 120 and image messaging server 140, in accordance with an illustrative embodiment of the present invention. It should be appreciated that FIG. 8 provides only an illustration of one implementation and does not imply any limitations with regard to the environments in which different embodiments may be implemented. Many modifications to the depicted environments may be made based on design and implementation requirements.

Computing system 800 is representative of any electronic device capable of executing machine-readable program instructions. Examples of computing systems, environments, and/or configurations that may be represented by computing system 800 include, but are not limited to, personal computer systems, server computer systems, thin clients, thick clients, laptop devices, tablet devices, cellular telephones, multiprocessor systems, microprocessor-based systems, network PCs, minicomputer systems, and distributed cloud computing environments that include any of the above systems or devices.

Computing devices 110 and 120 and image messaging server 140 include one or more buses 802, which provide for communications between one or more processors 804, memory 806, persistent storage 808, communications unit 812, and one or more input/output (IO) interfaces 814.

Memory 806 and persistent storage 808 are examples of computer-readable tangible storage media. Computer-readable tangible storage media are capable of storing information such as data, program code in functional form, and/or other suitable information on a temporary basis and/or permanent basis. Memory 806 can include one or more random access memories (RAM) 816, cache memory 818, or any other suitable volatile or non-volatile storage medium. In the embodiment illustrated in FIG. 8, persistent storage 808 is a magnetic disk storage medium of an internal hard drive. Alternatively, persistent storage 808 can be a semiconductor storage medium such as ROM, EPROM, flash memory or any other computer-readable tangible storage medium that can store a computer program and digital information. The media used by persistent storage 808 can also be removable. For example, a removable hard drive can be used for persistent storage 808. Other examples include optical or magnetic disks, thumb drives, or smart cards that are inserted into a drive for transfer onto another storage medium that is also a part of persistent storage 808.

Software 810 represents one or more operating systems and additional software that is stored in persistent storage 808 for execution by one or more of the respective processors 804 via one or more memories of memory 806. Software 810 includes one or more operating systems and any additional software in image messaging server 140, one or more operating systems, image messaging client 111, user authentication program 112, image file processing program 113, log program 114, and user prompt program 115 in computing device 110, and one or more operating systems, image messaging client 121, user authentication program 122, image file processing program 123, log program 124, and user prompt program 125 in computing device 120. As previously discussed, software 810 can be stored on removable media, from which it can be transferred onto another storage medium that is also part of persistent storage 808.

Communications unit 812 provides for communications with other computing systems or devices via network 130. In the embodiment illustrated in FIG. 8, communications unit 812 includes network adapters or interfaces such as a TCP/IP adapter cards, wireless Wi-Fi interface cards, or 3G or 4G wireless interface cards or other wired or wireless communication links. Software 810 can be stored on computer-readable tangible storage media of a remote computing system and downloaded to computing devices 110 and 120 from the external computing system via a network (for example, the Internet, a local area network or other wide area network) and communications unit 812. From communications unit 812, software 810 can then be loaded onto persistent storage 808. The network can comprise copper wires, optical fibers, wireless transmission, routers, firewalls, switches, gateway computers and/or edge servers.

One or more I/O interfaces 814 allow for input and output of data with other devices that may be connected to computing system 800. For example, I/O interface 814 can provide a connection to one or more external devices 820 such as a keyboard, computer mouse, touch screen, virtual keyboard, touch pad, pointing device, or other human interface devices. I/O interface 814 also connects to display 822.

Display 822 provides a mechanism to display data to a user of computing system 800 and can be, for example, a computer monitor. Alternatively, display 822 can be an incorporated display and may also function as a touch screen, such as, for example, a display of a cellular telephone or tablet computer that also functions as a touch screen.

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. A method for controlling access to a digital image, the method comprising the steps of:
a first computing device receiving a digital image from a second computing device;
the first computing device storing the digital image in local storage on the first computing device;
the first computing device displaying the digital image to an authorized user in a first user interface provided by the first computing device;
subsequently, the first computing device receiving instructions from the second computing device to disallow the digital image from being displayed in the first user interface; and
responsive to receiving the instructions from the second computing device, the first computing device deleting the digital image from local storage on the first computing device.

2. The method of claim 1, further comprising the step of responsive to receiving the instructions from the second computing device, the first computing device replacing the deleted digital image with another digital image specified by the second computing device.

3. The method of claim 1, further comprising the steps of:
the first computing device receiving at the first user interface a request to transmit a second digital image to another computing device;
responsive to receiving the request to transmit the second digital image, the first computing device transmitting the second digital image to the other computing device for display to an authorized user in a user interface provided by the other computing device;
subsequently, the first computing device receiving at the first user interface a request to transmit instructions to the other computing device to disallow the second digital image from being displayed in the user interface provided by the other computing device; and
responsive to receiving the request to transmit the instructions, the first computing device transmitting instructions to the other computing device that, when received by the other computing device, cause the other computing device to delete the digital image from local storage on the other computing device.

4. The method of claim 1, further comprising the step of the first computing device preventing an unauthorized user from accessing the digital image.

5. The method of claim 4, wherein the step of preventing an unauthorized user from accessing the digital image comprises at least one of the first computing device requiring a decryption key or password to display the digital image in the first user interface, the first computing device disabling print screen and other screen capture techniques on the first computing device, and the first computing device pulsing the display of the first computing device to obscure any view of the display by a third party or a camera.

6. The method of claim 1, wherein the digital image received is encrypted, and further comprising the step of the first computing device decrypting the encrypted digital image prior to the step of the first computing device displaying the digital image to an authorized user.

7. A computer system for controlling access to a digital image, the computer system comprising:
one or more processors;
at least one tangible, computer-readable memory for storing program instructions which when executed by the processor perform the steps of:
receiving a digital image from a second computing device;
storing the digital image in local storage;
displaying the digital image to an authorized user in a first user interface;
subsequently, receiving instructions from the second computing device to disallow the digital image from being displayed in the first user interface; and
responsive to receiving the instructions from the second computing device, deleting the digital image from local storage.

8. The computer system of claim 7, further comprising the step of responsive to receiving the instructions from the second computing device, replacing the deleted digital image with another digital image specified by the second computing device.

9. The computer system of claim 7, further comprising the steps of:
receiving at the first user interface a request to transmit a second digital image to another computing device;
responsive to receiving the request to transmit the second digital image, transmitting the second digital image to the other computing device for display to an authorized user in a user interface provided by the other computing device;
subsequently, receiving at the first user interface a request to transmit instructions to the other computing device to disallow the second digital image from being displayed in the user interface provided by the other computing device; and
responsive to receiving the request to transmit the instructions, transmitting instructions to the other computing device that, when received by the other computing device, cause the other computing device to delete the digital image from local storage on the other computing device.

10. The computer system of claim 7, further comprising the step of preventing an unauthorized user from accessing the digital image.

11. The computer system of claim 10, wherein the step of preventing an unauthorized user from accessing the digital image comprises at least one of requiring a decryption key or password to display the digital image in the first user interface, disabling print screen and other screen capture techniques, and pulsing the display to obscure any view of the display by a third party or a camera.

12. The computer system of claim 7, wherein the digital image received is encrypted, further comprising the step of decrypting the encrypted digital image prior to the step of displaying the digital image to an authorized user.

13. A computer program product for controlling access to a digital image, the computer program product comprising:
one or more computer-readable tangible storage media and program instructions stored on at least one of the one or more storage media which when executed by a processor perform the steps of:
receiving a digital image from a second computing device;
storing the digital image in local storage;
displaying the digital image to an authorized user in a first user interface;
subsequently, receiving instructions from the second computing device to disallow the digital image from being displayed in the first user interface; and
responsive to receiving the instructions from the second computing device, deleting the digital image from local storage.

14. The computer program product of claim 13, further comprising the step of responsive to receiving the instructions from the second computing device, replacing the deleted digital image with another digital image specified by the second computing device.

15. The computer program product of claim 13, further comprising the steps of:
receiving at the first user interface a request to transmit a second digital image to another computing device;
responsive to receiving the request to transmit the second digital image, transmitting the second digital image to the other computing device for display to an authorized user in a user interface provided by the other computing device;
subsequently, receiving at the first user interface a request to transmit instructions to the other computing device to disallow the second digital image from being displayed in the user interface provided by the other computing device; and
responsive to receiving the request to transmit the instructions, transmitting instructions to the other computing device that, when received by the other computing device, cause the other computing device to delete the digital image from local storage on the other computing device.

16. The computer program product of claim 13, further comprising the step of preventing an unauthorized user from accessing the digital image.

17. The computer program product of claim 16, wherein the step of preventing an unauthorized user from accessing the digital image comprises at least one of requiring a decryption key or password to display the digital image in the first user interface, disabling print screen and other screen capture techniques, and pulsing the display to obscure any view of the display by a third party or a camera.

18. The computer program product of claim 13, wherein the digital image received is encrypted, further comprising the step of decrypting the encrypted digital image prior to the step of displaying the digital image to an authorized user.

19. The computer program product of claim 13, wherein the program instructions stored on at least one of the one or more storage media were downloaded over a network from a remote computing system.

20. The computer program product of claim 13, wherein the program instructions stored on at least one of the one or more storage media are stored on at least one computer-readable tangible storage medium of a server computing system, and wherein the program instructions can be downloaded over a network by a remote computing system for storage on at least one computer-readable storage medium of the remote computing system.
